(19) United States
(12) Patent Application Publication
(10) Pub. No.: US 2009/0143057 A1
(43) Pub. Date: Jun. 4, 2009

(54) METHOD AND APPARATUS FOR DISTINCTIVE ALERT ACTIVATION

(75) Inventors: Raj Arun, Flower Mound, TX (US); Erik W. Pineas, Rockwall, TX (US)

Correspondence Address: VERIZON;PATENT MANAGEMENT GROUP, 1320 North Court House Road, 9th Floor, ARLINGTON, VA, 22201-2909, US

(73) Assignee: Verizon Services Organization Inc., Irving, TX (US)

(21) Appl. No.: 11/947,932

(22) Filed: Nov. 30, 2007

(51) Int. Cl. H04Q 7/20; H04M 3/00

(52) U.S. Cl. 455/418; 455/567; 455/414.1; 455/466

(57) ABSTRACT

An approach is provided activating a distinctive alert in a mobile station. An input from a user is received for generating an alert on a mobile station. In response to the input, a control signal is generated to activate the alert on the mobile station irrespective of any pre-existing alert setting of the mobile station.

### BACKGROUND INFORMATION

Modern lifestyles are becoming evermore reliant on mobile communications devices, such as cellular telephones, laptop computers, pagers, personal digital assistants (PDAs), and the like. Advances in technology, services, and affordability have further given rise to a host of “additional” features beyond that of ubiquitous voice communication, including functions like text/video messaging, multimedia playback, electronic mail, audio/video capturing, interactive gaming, data manipulation, web browsing, etc. With the ability to decorate, accessorize, or otherwise customize a mobile terminal, users have adopted these devices for near continual use. As such, the loss of a mobile terminal can not only deprive the user of these services, but the user risks divulging private or confidential information.

Because users generally have their mobile devices in close proximity nearly all the time, these devices have become the first choice for reaching the users in case of emergencies. However, although a user of the device can be reached in case of emergency situations, the user can be inundated with calls in which prioritization of such calls would be difficult.

Furthermore, service providers are continually challenged to develop new services and features to remain competitive and to develop new sources of revenue.

Therefore, there is a need for an approach that provides convenient, efficient techniques for finding a misplaced mobile device or reaching a user in case of emergency situations, while creating a new source of revenue for service providers.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of activating a distinctive alert, according to an exemplary embodiment;

FIG. 2 is a diagram of a mobile device including a distinctive alert activator, according to an exemplary embodiment;

FIG. 3 is a flowchart of a process for receiving distinctive alert information from a user, according to an exemplary embodiment;

FIG. 4 is a flowchart of a process for distinctive alert activation via a voicemail system, according to an exemplary embodiment;

FIG. 5 is a flowchart of a process for distinctive alert activation via a call center, according to an exemplary embodiment;

FIG. 6 is a flowchart of a process for distinctive alert activation via an application server, according to an exemplary embodiment;

FIG. 7 is a flowchart of a process for providing a mobile find-device service, according to an exemplary embodiment;

FIG. 8 is a flowchart of a process for providing an emergency/urgent override service, according to an exemplary embodiment; and

FIG. 9 is a diagram of a computer system that can be used to implement various exemplary embodiments.

### DESCRIPTION OF THE PREFERRED EMBODIMENT

A preferred apparatus, method, and software for distinctive alert activation are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

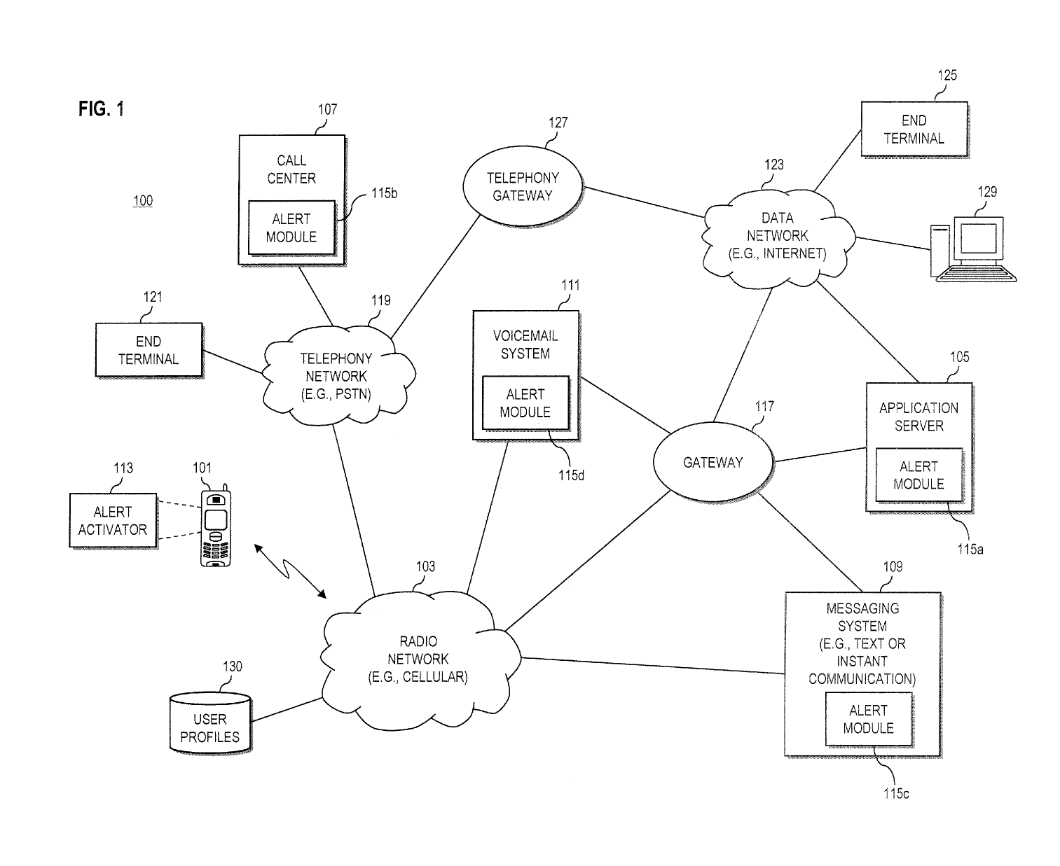

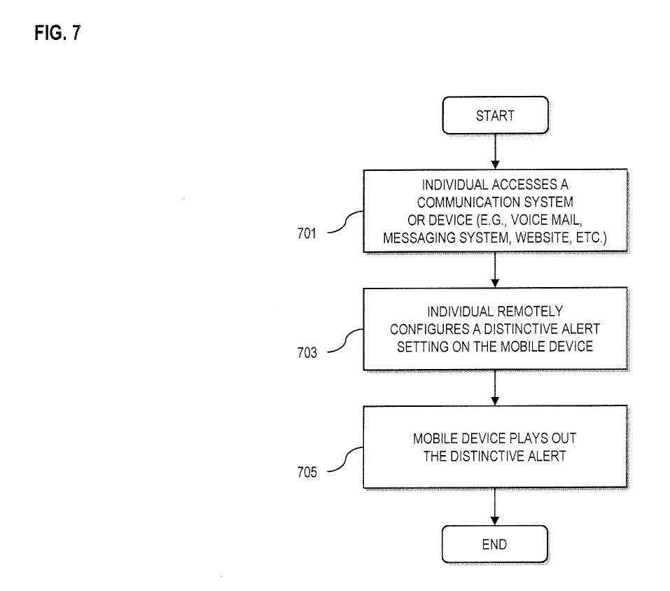

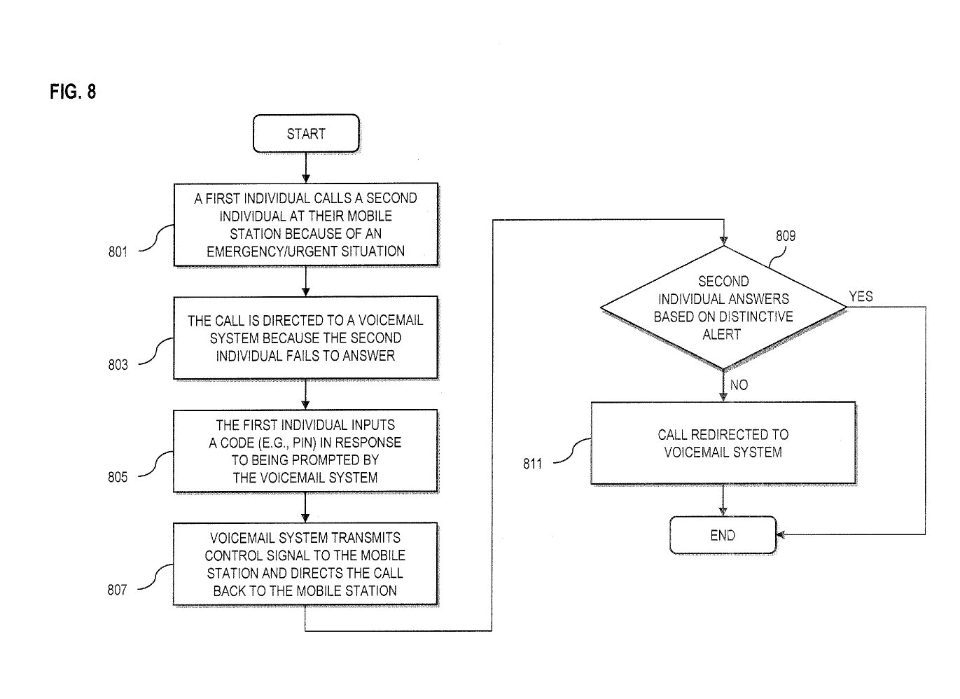

FIG. 1 is a diagram of a system capable of activating a distinctive alert on a mobile device, according to an exemplary embodiment. For the purposes of illustration, a system 100 for activating distinctive alerts, such as ringing tones (hereinafter “ringtones”), on a mobile unit 101 (e.g., a cellular telephone) is described with respect to a radio network 103, such as a cellular network, e.g., a code division multiple access (CDMA) network, enhanced data rates for global evolution (EDGE) network, general packet radio service (GPRS) network, global system for mobile communications (GSM) network, etc. While specific reference will be made thereto, it is contemplated that any radio (or otherwise wireless) network may be utilized, such as a microwave access (WiMAX) network, wireless fidelity (WiFi) network, satellite network, and the like. As used herein, the terms mobile units, mobile stations, mobile terminals, and mobile devices are interchangeable. Further, distinctive alerts include any aural, visual, and/or vibratory indicia. For the purposes of illustration, the distinctive alerting capability is described with respect to two applications: a “find-device” service, and an “emergency override” service. The find-device service permits a subscriber to instruct his/her mobile device to emit, for example, an audible indicator, even if the device is set for “silent” operation. Regarding the emergency override service, this service enables a user to notify the mobile device of a subscriber that an emergency call being attempted to the mobile device; that is, through this notification, an existing call can be considered overridden by the emergency call. These services are more fully described in FIGS. 7 and 8.

In the depicted embodiment, system 100 includes an application server 105, a call center 107, a messaging system (e.g., text or instant communication) 109, and a voicemail system (VMS) 111 that implement an alert service whereby a subscriber can remotely configure a distinctive alert setting on a mobile unit (e.g., mobile unit 101) via an alert activator 113 of the device. This alert service provides network-actuated distinctive alert configurations via one or more alert modules 115a-115d. Namely, alert modules 115a-115d enable the supporting communication network to transmit an appropriate configuration signal(s) to mobile device 101 for implementation via alert activator 113, which causes alert activator 113 to configure a distinctive alert setting(s) on mobile station 101. Thus, for example, if a user misplaces their mobile device 101, the individual may simply utilize the alert service of system 100 to cause mobile unit 101 to become more readily noticeable. That is, mobile unit 101 may be configured with a distinctive alert, e.g., an alert including aural, visual, and/or vibratory indicia, that makes finding mobile unit 101 less burdensome.

It is noted that the very Features which make mobile devices attractive also make finding them difficult at times, especially when those units are misplaced in unfamiliar settings. For instance, the reduced size of modern device designs provides convenience in terms of portability, but unfortunately makes such devices more prone to misplacement. It is also commonplace for individuals to configure their mobile stations with low volume, vibrate, or inaudible settings to avoid disturbing, unprofessional, or even embarrassing situations. In other instances, universally adopted ringtones cause the devices to be indistinguishable from one another. Thus, when a user misplaces their mobile station, simple solutions such as calling the device and listing for a distinctive ringtone become ineffective, if not wholly unavailable. Location-based services tend to alleviate these concerns; however, they generally only provide a “ballpark” location (e.g., an address) that must still be searched. For example, knowing your device is located at a high-rise office building or at a large retail-establishment (e.g., shopping mall) is certainly helpful, but rather unavailing without a way to abbreviate the search effort.

Moreover, when users configure their mobile stations with low volume, vibrate, or inaudible settings, there is also a potential to miss calls, messages, etc. For the most part, this is not a problem as the user may check for a “left” message (e.g., text, voice, video, etc.) or simply communicate with the other party later. During an emergency (or otherwise urgent) situation, it may be imperative that the user receives immediate notification and therefore, missing the call/message may result in dire consequences. In other instances, users may receive notification of an incoming call/message, but are oblivious to the actual purpose of the communication, which may cause the user to neglect to respond because they are “preoccupied.” Namely, because alerts, such as ringtones, are subject matter independent, a user has no way to distinguish the urgency of the communication beforehand.

Accordingly, alert activator 113 of mobile unit 101 addresses these concerns by permitting users to remotely configure a distinctive alert (or distinctive alert setting) of mobile unit 101. As such, when mobile device 101 is misplaced, the individual may simply employ the alert service of system 100 to configure the unit 101 to make the device 101 more readily conspicuous. Namely, mobile station 101 may be remotely configured to produce a distinctive alert, such as a high-level or intensity of aural, visual, and/or vibratory indicia, for making finding the device easier. Alert activator 113 of mobile unit 101 may also be employed by parties trying to reach the user of mobile unit 101 to signify an emergency (or otherwise urgent) situation. That is, another individual (other than the mobile station user) may remotely configure mobile device 101 to produce a distinctive alert to notify the mobile station user of the nature of the communication. Thus, the approach according to certain embodiments stems from the recognition that users can benefit from being able to configure their mobile devices with low volume, vibrate, or inaudible settings without having to worry that such settings will make finding their mobile stations burdensome when they are misplaced, or keep them from realizing the existence of an emergency/urgent situation.

As seen in FIG. 1, application server 105, call center 107, messaging system 109, and VMS 111 include an alert module 115a-115d, respectively, for generating commands, instructions, parameters, and/or signals (hereinafter collectively referred to as “control signals”) that may be executed on (or by) mobile unit 101 via alert activator 113. These control signals are utilized by alert activator 113 to generate, store, or otherwise implement configuration information based on the received control signal; the configuration information relating to one or more settings on mobile unit 101 corresponding to various alert parameters, such as aural, visual, or vibratory settings. According to one embodiment, control signals may also be utilized to “lock” mobile unit 101 until an appropriate “unlock” code (or signal) is input (or transmitted to) the device. As such, alert modules 115a-115d may issue control signals via various bearers, such as call control setup messages, short messages, extended messages, multimedia messages, electronic mail, files, or any other suitable bearer, as well as a combination thereof. In particular implementations, these bearer mediums may include control signals in various forms, including attention (AT) commands, menu traversal paths, function codes, voice data, dual-tone multi-frequency (DTMF) signals, scripts, strings, parameters, object variables, and the like. It is noted that these control signals can be used in lieu of “software code,” and therefore, may be directly integrated into the control logic of mobile unit 101, thereby requiring less processing and hence, less power. It is contemplated, however, that coded instructions may also be utilized.

Further, application server 105, call center 107, messaging system 109, and VMS 111 may operate as intermediaries for one another, i.e., one or more facilities may transmit control signals to mobile unit 101 in response to a request from another one or more facilities. Thus, alert activator 113 may be provided with one or more control signals in the form of one or more bearer mediums, whereby the control signals are executed to configure mobile station 101. Accordingly, if a mobile station 101 is set to a low volume, vibrate, or inaudible state, a control signal(s) may be transmitted to the device to remotely override such setting(s), thereby instituting a “new” distinctive alert setting. As previously mentioned, these settings may relate to aural, visual, or vibratory indicia. In particular instances, mobile unit 101 may be configured to announce (or publish) that the mobile station 101 is lost or misplaced. According to other embodiments, the distinctive alert may announce or publish the existence of an emergency/urgent incoming call, message, etc.

In this manner, control signals generated by alert modules 115a-115d can be transmitted to mobile unit 101 via radio network 103. Subscribers (or other authorized individuals) may interact with application server 105, call center 107, messaging system 109, and/or VMS 111 to remotely configure mobile unit 101 with a distinctive alert setting. To prevent unauthorized individuals from accessing the alert service of application server 105, call center 107, messaging system 109, and/or VMS 111, authentication information may be required. For instance, a username and password procedure may be employed. According to one embodiment, individuals may be required to enter a code (e.g., personal identification number (PIN), etc.) before accessing the functionality of application server 105, call center 107, messaging system 109, and/or VMS 111. Similarly, to prevent the implementation of unauthorized control signals otherwise received at mobile station 101, application server 105, call center 107, messaging system 109, and/or VMS 111 may include an authentication identifier when transmitting control signals to mobile station 101. For instance, control signals may be encrypted, either symmetrically or asymmetrically, such that a hash value can be utilized to authenticate received control signals, as well as ensure that those control signals have not been alerted in transit. As such, control signals may include various identifiers, keys, random numbers, random handshakes, digital signatures, and the like. Further, these authenticating schemas may themselves be encrypted, or otherwise secured.

As seen in FIG. 1, messaging system 109 and VMS 111 may directly interface with radio network 103, such that control signals generated at messaging system 109 and VMS 111 can be transmitted to mobile station 101 via radio network 103. Meanwhile, application server 105 can transmit control signals to mobile unit 101 over radio network 103 via a gateway 117, such as a cellular gateway, e.g., a wireless application protocol (WAP) gateway. Although a single gateway 117 is shown, multiple gateways may be utilized depending on the particular applications and technologies employed.

Call center 107 may transmit control signals to mobile unit 101 over radio network 103 via a telephony network 119, e.g., the Public Switched Telephone Network (PSTN), that supports an end terminal(s) 121, such as a plain old telephone service (POTS) device. According to other embodiments, application server 105, messaging system 109, and VMS 111 may also establish connectivity (either directly or via gateway 117) to a data network 123, such as the Internet, that supports an end terminal(s) 125 and/or a host(s) 127. End terminal 125 may be any computing device capable of packetized voice communications, such as a Voice over Internet Protocol (VoIP) device. Host 127 may similarly comprise a computing device; however, may utilize a graphical user interface (GUI), such as a browser application or any other web-based application, to interact with application server 105, call center 107, messaging system 109, or VMS 111. As such, data network 123 may interface with telephony network 119 via a telephony gateway 127. According to one embodiment, authorized individuals may generate control signals via end terminals 121 and 125, as well as via host 129 or another mobile station (not shown) utilizing a locally resident alert module (not illustrated) and transmit those control signals to mobile station 101 over one or more of the networks of system 100, without having to access application server 105, call center 107, messaging system 109, and/or VMS 111.

System 100 may also include a user profiles database 130 for storing subscriber information, such as billing information, contact information, demographic information, location information, mobile station configurations, subscription parameters, and the like. User profiles database 130 may also be utilized to store data relating to authorized users of the alert service of system 100, as well as associated authorization information corresponding to those users. Namely, the user of mobile station 101 may establish one or more sub-profiles including usernames, passwords, codes, PINs, distinctive alert settings, etc. to further distinguish various override scenarios. By way of example, a first sub-profile may be utilized by the user of mobile station 101 for situations when mobile unit 101 is misplaced. A second sub-profile may be generated for emergency situations corresponding to family and/or friends. Further, a third sub-profile may be generated for urgent business-related situations. In this manner, any number of sub-profiles may be utilized to further distinguish the subject matter and/or urgency of a communication. For the purposes of brevity, the aforementioned informational types and sub-profiles are, hereinafter, collectively referred to as “distinctive alert information.” While user profiles database 130 is depicted as an extension of radio network 103, it is contemplated that user profiles database 130 can be integrated into, collocated at, or otherwise in communication with any of the components of system 100.

Thus, a subscriber of (or an individual authorized to use) the alert service of system 100 may initialize a communication session at end terminals 121 and 125, as well as at host 129 or another mobile unit (not shown) to interact with alert modules 115a-115d of application server 105, call center 107, messaging system 109, VMS 111, respectively, so as to remotely configure mobile station 101. Furthermore, although the distinctive alert service is described with respect to a mobile device 101, it is recognized that distinctive alerts can be applied to any device capable of providing voice communications, such as end terminals 121 and 125, as well as host 129. While system 100 has been described in accordance with the depicted embodiment of FIG. 1, it is contemplated that system 100 may embody many forms and include multiple and/or alternative components and facilities.

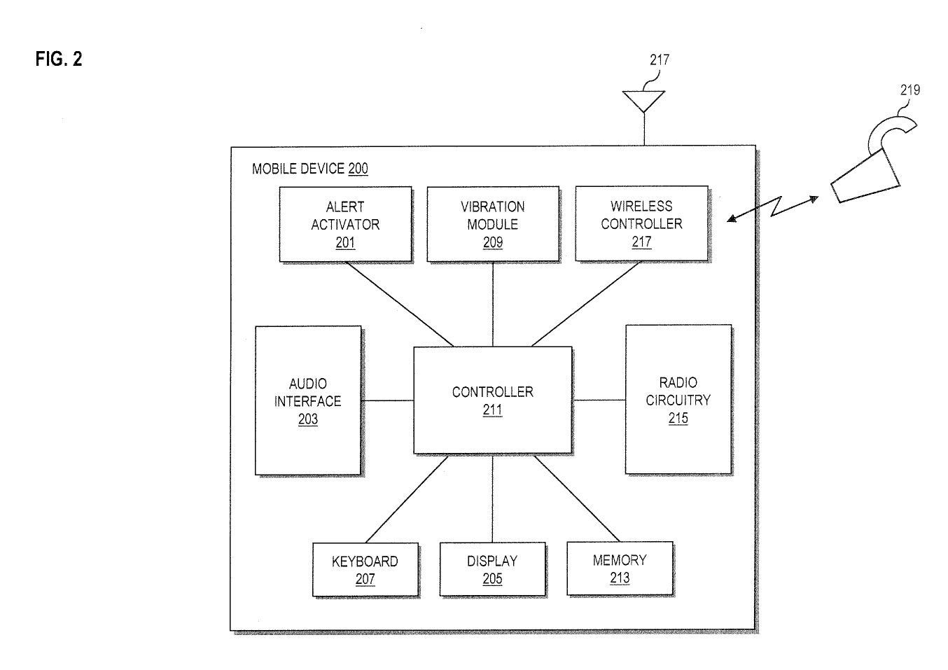

FIG. 2 is a diagram of a mobile device including a distinctive alert activator, according to an exemplary embodiment. In the depicted embodiment, a mobile device 200 includes an alert activator 201 to effectuate the implementation of control signals received from application server 105, call center 107, messaging system 109, and/or VMS 111, as well as from end terminals 121 and 125, host 129, or another mobile station. The control signals are utilized by alert activator 201 to invoke an appropriate distinctive alert setting, e.g., an alert combining aural, visual, and/or vibratory indicia. In this manner, aural indicia (e.g., ringtones) are played out by an audio interface 203, as part of an audio function circuitry (not shown) that includes a microphone and microphone amplifier that amplifies a sound signal output from the microphone. Such sound signal outputs may be fed to a coder/decoder (CODEC) for appropriate processing. Visual indicia (e.g., a light emitting diode (LED)) can be animated at a display unit 205, a backlit keyboard 207, or other LED or lighting device of mobile device 200. Meanwhile, mechanical vibration (i.e., vibratory indicia) can be realized through a vibration module 209.

A controller 211 is provided to control the functions of audio interface 203, display unit 205, and vibration module 209, as well as keyboard 207, and a memory 213. A user can input information (e.g., user profile information, control signal requests, other alphanumeric input, and the like) via keyboard 207. It is noted that mobile device 200 may additionally (or alternatively) include other input mechanisms, such as a touch screen (not shown). Display unit 205 also provides a display to the user in support of various applications and mobile station functions. In conjunction with display unit 205, controller 211 may enable applications including a short message service (SMS) application, a multimedia messaging service (MMS) application, WAP applications, database management applications, and data exchange applications, as well as any other suitable application. Memory 213 may be utilized to store various configuration settings of mobile device 200, as well as store received control signals for use by alert activator 201.

According to one embodiment, alert activator 201 in conjunction with the controller 211, designates and controls the appropriate distinctive features (e.g., aural, visual, and vibratory indicia) on mobile device 200 for a given set of circumstances, as dictated by a received control signal that may specify certain parameters governing alerts. These parameters may include sound settings (e.g., ringtone style, volume, duration, etc.), visual settings (e.g., color, intensity, lighting sequence, etc.), and vibratory settings (e.g., intensity, pulsating sequence, etc.), as well as any other suitable parameter governing the operation of mobile station 200. Hence, alert activator 201 utilizes the above parameters (stored in memory 213) to control the distinctive alert settings of mobile device 200.

In addition, the mobile device 200 employs radio circuitry 215 to communicate over radio network 103 (of FIG. 1) using radio frequency (RF) signaling. Radio circuitry 215 can be defined in terms of front-end and back-end characteristics. The front-end encompasses all of the RF circuitry, whereas the back-end encompasses all of the base-band processing circuitry. For the purposes explanation, voice/control signals transmitted to mobile device 200 can be received via antenna 217 and immediately amplified by a low noise amplifier (LNA). A down-converter can lower the carrier frequency, while a demodulator may strip away the RF leaving only a digital bit stream. The signal can go through an equalizer and may be processed by, for instance, a digital signal processor (DSP). The DSP may, depending upon the implementation, perform any of a variety of conventional digital processing functions on the received signals. For voice signals, in particular, the DSP may also determine a background noise level of a local environment from the signals detected by a microphone of audio interface 203, and set a gain of the microphone at a level to compensate for the natural tendencies of a user. A digital-to-analog converter (DAC) can convert voice signals and the resulting output may be transmitted to the user through a speaker of audio interface 203, as controlled by controller 211. Control signals may be stored to memory 213 and/or implemented via alert activator 201.

During voice transmission, a user can speak into the microphone and his/her voice, along with any detected background noise, can be converted into an analog voltage. The analog voltage may then be converted into a digital signal through an analog-to-digital converter (ADC). Controller 211 routes the digital signal into the DSP for processing therein, such as speech encoding, channel encoding, encrypting, and interleaving. The encoded signals can be routed to an equalizer for compensation of any frequency-dependent impairments that occur during transmission though the air, such as phase and amplitude distortion. After equalizing the bit stream, a modulator may combine the signal with an RF signal generated by radio circuitry 215.

The modulator can generate, for instance, a sine wave by way of frequency and/or phase modulation. In order to prepare the signal for transmission, an up-converter may combine the sine wave output from the modulator with another sine wave generated by a synthesizer to achieve the desired frequency of transmission. The signal can then be sent through a power amplifier (PA) to increase the signal to an appropriate power level. In practical systems, the PA acts as a variable gain amplifier whose gain is controlled by the DSP from information received from a network base station. The signal is then filtered within a duplexer and optionally sent to an antenna coupler to match impedances to provide maximum power transfer. Finally, the signal is transmitted via antenna 217 to a local base station of radio network 103. An automatic gain control (AGC) can be supplied to control the gain of the final stages of radio circuitry 215. The signals may be forwarded from there to a remote end terminal which may be another mobile station, a landline end terminal 121 connected to telephony network 119, or an end terminal 125 or host 129 connected to data network 123. In other instances, mobile station 200 may be utilized to interact with application server 105, call center 107, messaging system 109, and/or VMS 111.

Furthermore, the mobile device 200 can optionally be equipped with a wireless controller 218 to communicate with a wireless headset 219. The headset 219 can employ any number of standard radio technology to communicate with the wireless controller 218; for example, the headset 219 can be BLUETOOTH enabled. It is contemplated that other equivalent short range radio technology and protocols can be utilized. While mobile device 200 has been described in accordance with the depicted embodiment of FIG. 2, it is contemplated that mobile device 200 may embody many forms and include multiple and/or alternative components.

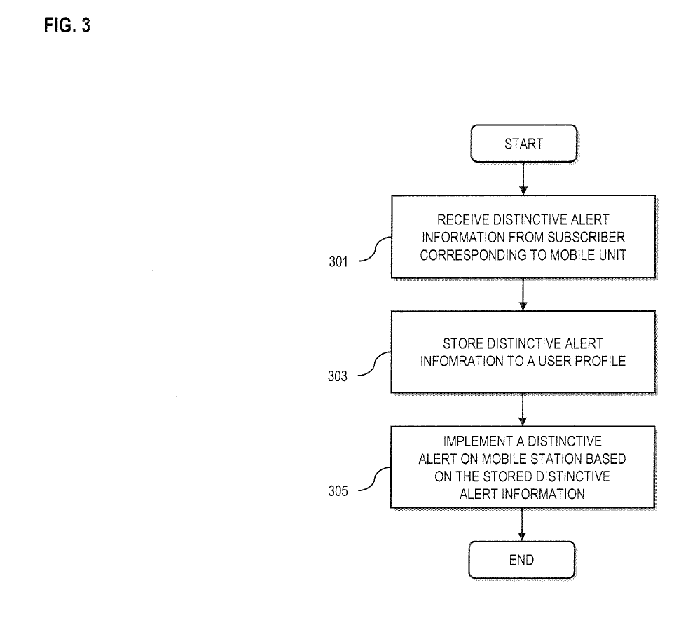

FIG. 3 is a flowchart of a process for receiving distinctive alert information from a user, according to an exemplary embodiment. In step 301, distinctive alert information (or parameters) is received from the user. According to an exemplary embodiment, the user can input the information using keyboard 207 of mobile device 200. In the alternative, this information can be remotely entered by host 129 using a web browser interfacing with, for example, a user profile building application of application server 105. According to other embodiments, users may initialize a communication session with a call center 107 via an end terminal 121 or 125. In this manner, call center 107 can include a text-to-speech (TTS) and/or an automatic speech recognition engine for converting analog to digital signals and vice versa. As such, when a user interacts with call center 107 using a voice transmission, the speech recognition engine is configured to covert spoken language (analog signal) into textual form (digital signal) for processing by call center 107. Meanwhile, the TTS engine coverts textual information (digital signal) from call center 107 to speech (analog signal) for playback to the user at end terminal 121 or 125. As such, a communication session may be established by sending and receiving information using voice protocols, e.g., voice extensible markup language (VXML) programs. It is contemplated, however, that the TTS and/or speech recognition engines may be collocated with or integrated into telephony network 119 or other component/facility of system 100. Further, TTS and/or speech recognition functionality can be implemented on end terminals 121, 125, host 129, and/or a mobile station (e.g., mobile station 101). According to other embodiments, users at end terminals 121 and 125 may relay distinctive alert information to a customer service representative who may then record the information using, for instance, host 129 interfacing with application server 105.

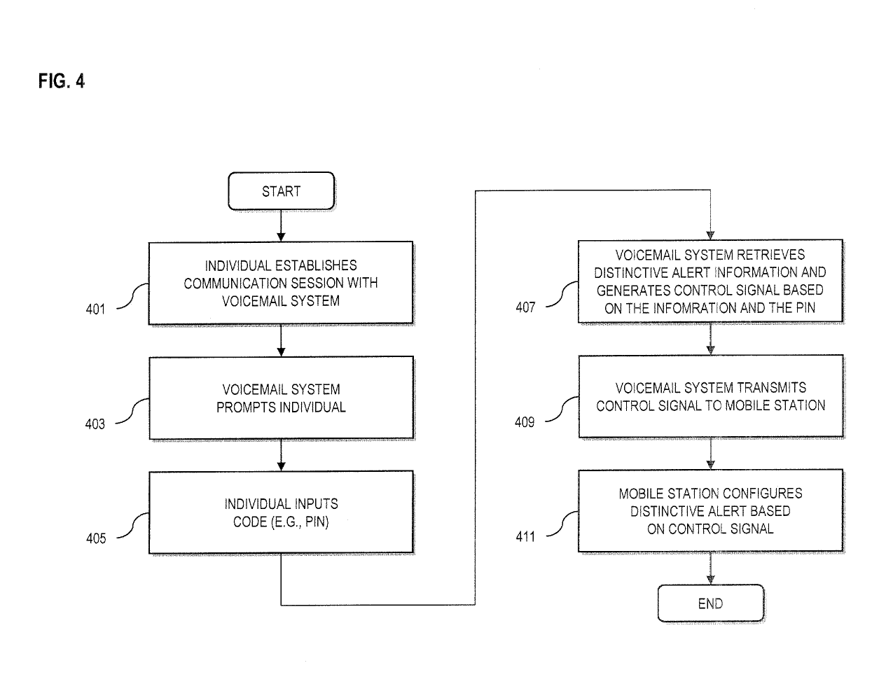

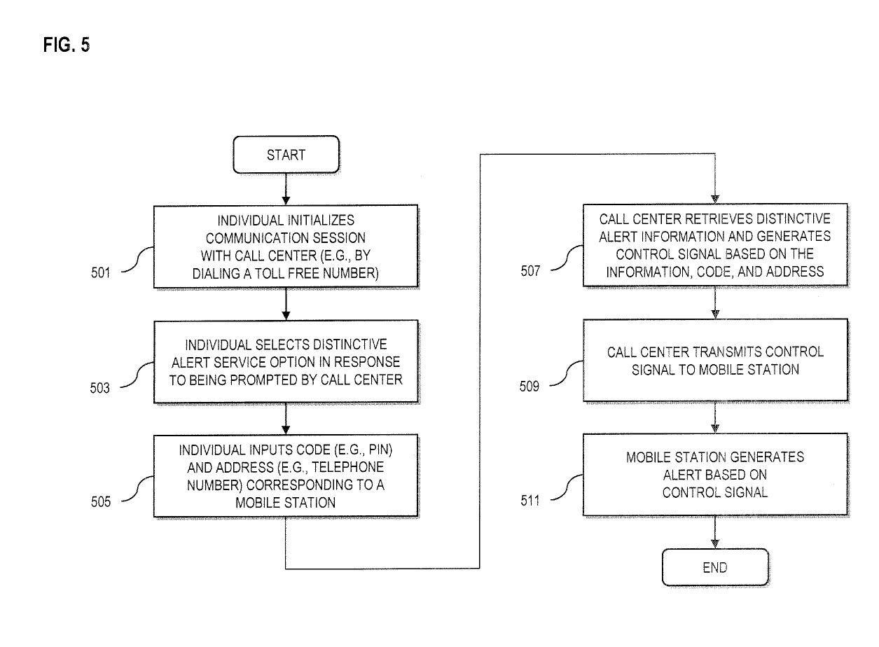

As such, the received distinctive alert information can be stored, as in step 303, in user profiles database 130. According to other embodiments, this information may be additionally (or alternatively) stored to memory 213 of mobile device 200, or another repository (not illustrated) of system 100, such as a memory or database of application server 105, call center 107, messaging system 109, and/or VMS 111. In accordance with a distinctive alert configuration procedure, various distinctive alerts, e.g., aural, visual, and/or vibratory indicia, are executed via audio interface 203, display unit 205, keyboard 207, vibration module 209, or other suitable component of mobile device 200, per step 305, based on the distinctive alert information stored to user profile database 130. To implement a distinctive alert configuration procedure, alert activator 201 employs a monitoring process for a control signal which triggers the configuration of a distinctive alert on mobile station 200, as described with respect to FIGS. 4 and 5.

FIG. 4 is a flowchart of a process for distinctive alert activation via a voicemail system, according to an exemplary embodiment. In step 401, an individual or user (e.g., subscriber) establishes a communication session with VMS 111 via end terminal 121, 125, or another mobile station, i.e., a mobile station other than mobile station 101. This communication session may be directly established by “calling” VMS 111. In the alternative, the individual may first “call” mobile station 101, such that when the incoming call is not answered, the communication session may be directed to, and handled by, VMS 111. At step 403, VMS 111 may prompt the individual with conventional voicemail instructions/options. According to one embodiment, VMS 111 may provide a specific “ALERT CONFIGURATION” option. At step 405, the individual may input a code, such as a personal identification number (PIN), thereby activating alert module 115d. Based on the input code and the mobile station the individual was attempting to reach, VMS 111 may then retrieve corresponding distinctive alert information from user profiles database 130, as in step 407. Specifically utilizing the input code, alert module 115d may extract particularized aural, visual, or vibratory information/settings stored to a sub-profile. According to other embodiments, a service provider may simply provide “batched” distinctive alert settings, whereby user profile information may not be required. Based on the input code and distinctive alert information, alert module 115d may then generate a control signal for configuring a distinctive alert on mobile station 101, via alert activator 201. In the alternative, VMS 111 may request application server 105, call center 107, or messaging system 109 to generate the control signal. As such, a control signal may be generated in the form of AT command(s), menu traversal path(s), function code(s), voice data, dual-tone multi-frequency (DTMF) signal(s), script(s), string(s), parameter(s), object variable(s), and/or the like. Further, generated control signal(s) may be couched within a transmission bearer, such as a call control setup message, short message, extended message, multimedia message, electronic mail, file, or any other suitable bearer, as well as a combination thereof.

At step 409, the control signal is transmitted from VMS 111 to mobile station 101 via radio network 103. This may be achieved directly or routed through gateway 117, data network 123, telephony gateway 127, and/or telephony network 119. As previously mentioned, application server 105, call center 107, or messaging system 109 may serve as an intermediary control signal generator, whereby the control signal can be transmitted to mobile station 101 via the intermediary facility or transmitted to VMS 111 and then to mobile station 101. According to one embodiment, alert module 115d may include (or otherwise transmit) an encrypted hash value generated based on the control signal.

In response to receiving the control signal, alert activator 113 of mobile unit 101 may “wake up.” In other instances, the control signal may trigger alert activator 113 into execution. As such, mobile unit 101 may then authenticate the control signal by, for example, decrypting the transmission, calculating a hash value based on the decrypted transmission, and then comparing the received hash value and the calculated hash value. If the hash values are the same, the transmission may be considered secure. For added security, digital signatures may also be implemented. It is noted that the aforementioned authentication scheme is merely exemplary and is not intended to limit the validation of control signals received at mobile unit 101.

Assuming a valid, unaltered, or otherwise authenticated control signal, mobile unit 101, via alert activator 113, responds by, for example, changing a configuration of the device, i.e., by configuring a distinctive alert setting, as in step 411. This configuration would override a then “current” alert setting, such as a low volume, vibrate, or inaudible setting. According to one embodiment, mobile unit 101 may acknowledge a reconfiguration procedure by transmitting an appropriate signal back to VMS 111. Further, alert activator 113 may “lock” mobile unit 101 until an appropriate “unlock” code (or signal) is input (or transmitted to) the device, such as when an individual finds mobile unit 101. Accordingly, the distinctive alert configuration may then cause mobile unit 101 to begin playing out the distinctive alert via audio interface 203, display 205, keyboard 207, and/or vibration module 209, as well as via any other suitable component of mobile unit 101, e.g., a visual indicator, such as a supplementary light emitting diode (LED). In other instances, the individual may be required to “call” mobile unit 101 for the distinctive alert to be implemented. As such, an individual may exercise remote control over the distinctive alert settings of mobile unit 101, which can be utilized to help find the mobile unit when it is lost or misplaced.

FIG. 5 is a flowchart of a process for distinctive alert activation via a call center, according to an exemplary embodiment. In step 501, an individual establishes a communication session with call center 107 via end terminal 121, 125, host 129, or another mobile station, i.e., a mobile station other than mobile station 101. This communication session may be established by the individual dialing a telephone number (e.g., a toll-free number) of call center 107. At step 503, the individual selects an “ALERT CONFIGURATION” option via, for instance, a DTMF signal (e.g., depresses “1” on a touchtone telephone) in response to being prompted by a menu of options provided by call center 107. Based on the selection, the menu of options may request an address of a mobile station to be remotely controlled and a corresponding code for effectuating the alert service. According to one embodiment, the individual may, per step 505, input the address (e.g., telephone number, machine identifier, media access control (MAC) address, internet protocol (IP) address, etc.) of mobile unit 101, as well as an authorization code (e.g., a PIN, code, password, etc.).

In step 507, call center 107 may retrieve, based on the mobile station address and input code, corresponding distinctive alert information concerning mobile unit 101. Specifically utilizing the input code, alert module 115b may extract particularized aural, visual, or vibratory information/settings stored to a sub-profile. According to other embodiments, a service provider may simply provide “batched” distinctive alert settings, whereby user profile information may not be required. Based on the input code and distinctive alert information, alert module 115b may then generate a control signal for configuring a distinctive alert on mobile station 101, via alert activator 113. In the alternative, call center 107 may request application server 105, messaging system 109, and/or VMS 111 to generate the control signal(s). As such, a control signal(s) may be generated in the form of AT command(s), menu traversal path(s), function code(s), voice data, dual-tone multi-frequency (DTMF) signal(s), script(s), string(s), parameter(s), object variable(s), and/or the like. Further, the generated control signal(s) may be couched within a transmission bearer, such as a call control setup message, short message, extended message, multimedia message, electronic mail, file, or any other suitable bearer, as well as a combination thereof.

At step 509, the control signal(s) is transmitted from call center 107 to mobile station 101 via radio network 103 by way of telephony network 119. In the alternative, the control signal(s) may be routed through telephony gateway 127, data network 123, and gateway 117. As previously mentioned, application server 105, messaging system 109, and/or VMS 111 may serve as an intermediary control signal generator, whereby the control signal can be transmitted to mobile station 101 via the intermediary facility or transmitted to call center 107 and then forwarded to mobile station 101. According to one embodiment, alert module 115d may also include (or otherwise transmit) an encrypted hash value generated based on the control signal, as well as a digital signature, etc., to mobile station 101 for authentication/validation purposes. In response to receiving the control signal, alert activator 113 of mobile unit 101 may “wake up.” In other instances, the control signal may trigger alert activator 113 into execution.

Once activated, alert activator 113 may authenticate/validate the control signal. If the control signal is valid, unaltered, or otherwise authentic, alert activator 113 can respond by, for example, changing a configuration of the device, i.e., by configuring a distinctive alert setting, as in step 511. This configuration overrides a then “current” alert setting on mobile device 101. According to one embodiment, mobile unit 101 may acknowledge a reconfiguration procedure by transmitting an appropriate signal back to call center 107. Further, alert activator 113 may “lock” mobile unit 101 until an appropriate “unlock” code (or signal) is input (or transmitted to) the device, such as when an individual finds mobile unit 101. Accordingly, the distinctive alert configuration may then cause mobile unit 101 to begin playing out the distinctive alert via audio interface 203, display 205, keyboard 207, and/or vibration module 209, as well as via any other suitable component of mobile unit 101, e.g., a supplementary LED. In other instances, the individual may be required to “call” mobile unit 101 for the distinctive alert to be implemented.

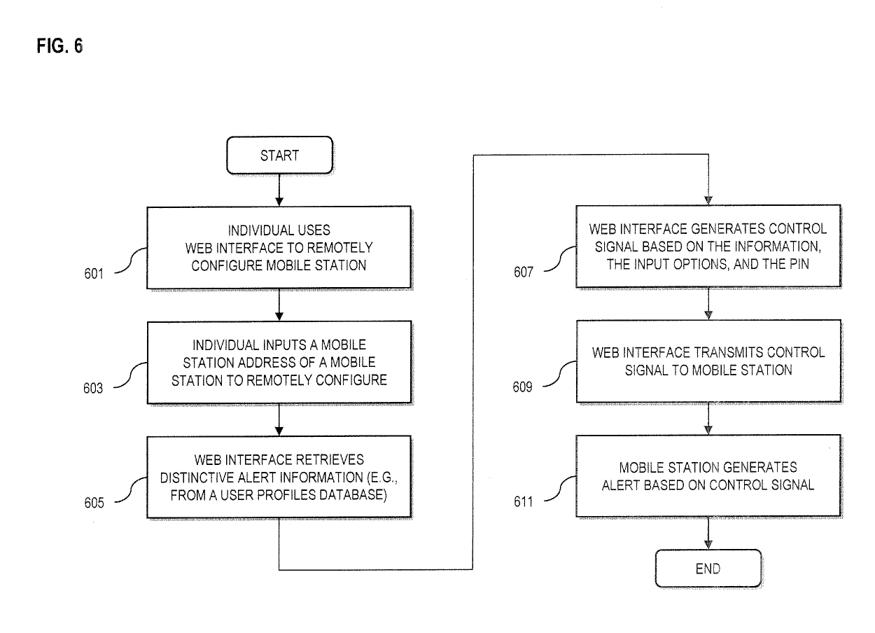

FIG. 6 is a flowchart of a process for distinctive alert activation via an application server, according to an exemplary embodiment. In step 601, an individual establishes a communication session with application server 105 via, for instance, host 129 or another mobile station, i.e., a mobile station other than mobile station 101. This communication session may be established via a web interface, i.e., the individual may utilize a browser application executed on (or by) host 129 or the mobile station to access the alert service of application server 105. In particular implementations, the web interface may access, for instance, messaging system 109. Before gaining access, however, the individual may be required to “log on” to application server 105 by, for instance, providing a username and password combination, or other suitable authorization information. Once “logged on,” the individual may input an address (e.g., telephone number, machine identifier, media access control (MAC) address, internet protocol (IP) address, etc.) of mobile unit 101, per step 603.

In step 605, application server 105 may retrieve, based on the mobile station address, corresponding distinctive alert information concerning the mobile unit 101. Alert module 115a may extract aural, visual, or vibratory information/settings stored to a sub-profile based on the username/password combination utilized to “log on” to application server 105. According to other embodiments, a service provider may simply provide “batched” distinctive alert settings, whereby user profile information may not be required. Utilizing the extracted distinctive alert information, alert module 115a may generate a control signal, as per step 607, for configuring a distinctive alert on mobile station 101, via alert activator 113. In the alternative, application server 105 may request call center 107, messaging system 109, and/or VMS 111 to generate the control signal(s). As such, a control signal(s) may be generated in the form of AT command(s), menu traversal path(s), function code(s), voice data, dual-tone multi-frequency (DTMF) signal(s), script(s), string(s), parameter(s), object variable(s), and/or the like. Further, the generated control signal(s) may be couched within a transmission bearer, such as a call control setup message, short message, extended message, multimedia message, electronic mail, file, or any other suitable bearer, as well as a combination thereof.

At step 609, the control signal(s) is transmitted from application server 105 to mobile station 101 via radio network 103 by way of gateway 117. In the alternative, the control signal(s) may be routed through data network 123, telephony gateway 127, and telephony network 119. As previously mentioned, call center 107, messaging system 109, and/or VMS 111 may serve as an intermediary control signal generator, whereby the control signal can be transmitted to mobile station 101 via the intermediary facility or transmitted to application server 105 and then forwarded to mobile station 101. According to one embodiment, alert module 115a may also include (or otherwise transmit) an encrypted hash value generated based on the control signal, as well as a digital signature, etc., to mobile station 101 for authentication/validation purposes. In response to receiving the control signal, alert activator 113 of mobile unit 101 may “wake up.” In other instances, the control signal may trigger alert activator 113 into execution.

Once activated, alert activator 113 may authenticate/validate the control signal. If the control signal is valid, unaltered, or otherwise authentic, alert activator 113 can respond by, for example, changing a configuration of the device, i.e., by configuring a distinctive alert setting, as in step 611. This configuration overrides a then “current” alert setting on mobile device 101. According to one embodiment, mobile unit 101 may acknowledge a reconfiguration procedure by transmitting an appropriate signal back to application server 105. Further, alert activator 113 may “lock” mobile unit 101 until an appropriate “unlock” code (or signal) is input (or transmitted to) the device, such as when an individual finds mobile unit 101. Accordingly, the distinctive alert configuration may then cause mobile unit 101 to begin playing out the distinctive alert via audio interface 203, display 205, keyboard 207, and/or vibration module 209, as well as via any other suitable component of mobile unit 101, e.g., a supplementary LED. In other instances, the individual may be required to “call” mobile unit 101 for the distinctive alert to be implemented.

FIG. 7 is a flowchart of a process for providing a mobile find-device service, according to an exemplary embodiment. By way of example, a find-device service is described, whereby if a subscriber loses his/her mobile station (e.g., cellular phone), the service can help locate the device. An individual realizes he/she has misplaced mobile unit 101. Consequently, the individual accesses a communication system or device to initiate a find-device service, as in step 701. Per step 703, the individual may remotely configure a distinctive alert setting on mobile unit 101 by, for example, utilizing one or more of the processes of FIGS. 4-6. Based on the chosen procedure, mobile unit 101 may play out the newly configured distinctive alert, as in step 705. With this alert, the mobile unit 101 emit the specified indicia by perceiving (hearing, viewing, and/or feeling) the distinctive alert as it plays out.

FIG. 8 is a flowchart of a process for providing an emergency/urgent override service, according to an exemplary embodiment. Under this scenario, the process can be a part of a telecommunication service (i.e., emergency/urgent service), whereby a subscriber is notified of an emergency event or condition. In step 801, a first individual (e.g., caller), via end terminal 121, 125, host 129, or another mobile station may call a second individual (e.g., called party or subscriber) at their mobile station (e.g., mobile station 101) to notify the called party of an emergency/urgent situation. In a first scenario, the called party may have mobile station 101 set to a low volume, vibrate, or inaudible setting and, therefore, failed to answer because they failed to perceive the incoming communication. In a second scenario, the called party may have failed to answer because they were unaware of the true nature, i.e., subject matter, of the communication and were otherwise “preoccupied.” Whatever the reason, the call may be directed to VMS 111, as per step 803. At step 805, the caller may input an individualized code (e.g., a PIN) that was previously provided to the caller by the called party in response to being prompted by VMS 111. Upon entering the code, VMS 111 may retrieve corresponding distinctive alert information from user profiles database 130 based on the code and the mobile unit 101 that the caller was attempting to reach.

Specifically utilizing the code, alert module 115d may extract aural, visual, or vibratory information/settings stored to a sub-profile corresponding to the caller. Based on the extracted information, alert module 115d may then generate a control signal for configuring a distinctive alert on mobile station 101, via alert activator 113. In the alternative, VMS 111 may request application server 105, call center 107, or messaging system 109 to generate the control signal. As such, a control signal may be generated in the form of AT command(s), menu traversal path(s), function code(s), voice data, dual-tone multi-frequency (DTMF) signal(s), script(s), string(s), parameter(s), object variable(s), and/or the like. Further, generated control signal(s) may be couched within a transmission bearer, such as a call control setup message, short message, extended message, multimedia message, electronic mail, file, or any other suitable bearer, as well as a combination thereof.

At step 807, the control signal is transmitted to mobile station 101. In response, alert activator 113 of mobile unit 101 may “wake up,” authenticate/validate the control signal, and/or configure a distinctive alert setting on the mobile station 101 based on the received control signal. According to the first scenario, this configuration would override the low volume, vibrate, or inaudible setting previously configured by the called party. According to both the first and second scenarios, reconfiguring the distinctive alert is utilized to notify the called party as to the nature of the communication, i.e., that the call concerns an emergency/urgent situation. In particular instances, mobile unit 101 may acknowledge the configuration of the “new” distinctive alert by transmitting an appropriate signal back to VMS 111, at which point VMS 111 may transfer the communication session back to mobile station 101. As such, mobile station 101 may play out the “new” distinctive alert in response to the incoming communication.

Upon perceiving the distinctive alert, the called party may or may not answer, as in step 809; however, will be able to readily understand that the communication concerns an emergency/urgent situation based on the distinctive alert. If the called party answers, the caller may inform the called party of the situation and the process ends. If the called party does not answer, the call may be redirected back to VMS 111, wherein the caller may leave a message for the second user, per step 811. According to one embodiment, upon leaving the message, VMS 111 may itself or request messaging system 109 to transmit an emergency/urgent message to mobile station 101. In response to receiving this message, alert activator 113 may further configure display unit 205 to present the message. As such, individuals may exercise remote control over the distinctive alert settings of mobile unit 101, which can be utilized to help notify mobile station users of an emergency/urgent situation.

The processes described herein for distinctive alert activation may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

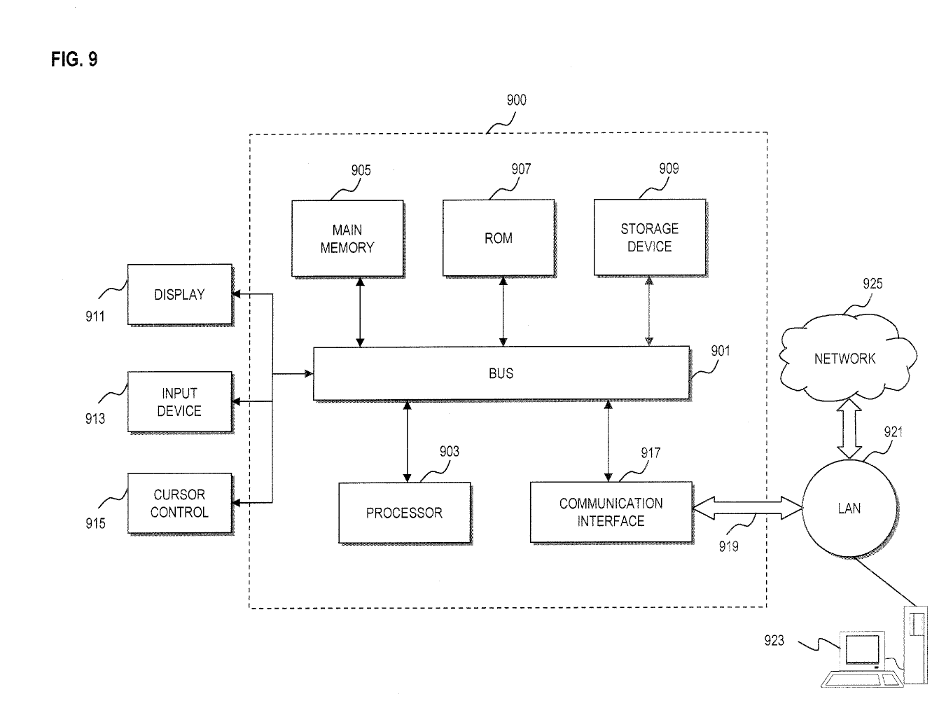

FIG. 9 illustrates computing hardware (e.g., computer system) 900 upon which an embodiment according to the invention can be implemented. The computer system 900 includes a bus 901 or other communication mechanism for communicating information and a processor 903 coupled to the bus 901 for processing information. The computer system 900 also includes main memory 905, such as a random access memory (RAM) or other dynamic storage device, coupled to the bus 901 for storing information and instructions to be executed by the processor 903. Main memory 905 can also be used for storing temporary variables or other intermediate information during execution of instructions by the processor 903. The computer system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computer system 900 may be coupled via the bus 901 to a display 911, such as a cathode ray tube (CRT), liquid crystal display, active matrix display, or plasma display, for displaying information to a computer user. An input device 913, such as a keyboard including alphanumeric and other keys, is coupled to the bus 901 for communicating information and command selections to the processor 903. Another type of user input device is a cursor control 915, such as a mouse, a trackball, or cursor direction keys, for communicating direction information and command selections to the processor 903 and for controlling cursor movement on the display 911.

According to an embodiment of the invention, the processes described herein are performed by the computer system 900, in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multi-processing arrangement may also be employed to execute the instructions contained in main memory 905. In alternative embodiments, hard-wired circuitry may be used in place of or in combination with software instructions to implement the embodiment of the invention. Thus, embodiments of the invention are not limited to any specific combination of hardware circuitry and software.

The computer system 900 also includes a communication interface 917 coupled to bus 901. The communication interface 917 provides a two-way data communication coupling to a network link 919 connected to a local network 921. For example, the communication interface 917 may be a digital subscriber line (DSL) card or modem, an integrated services digital network (ISDN) card, a cable modem, a telephone modem, or any other communication interface to provide a data communication connection to a corresponding type of communication line. As another example, communication interface 917 may be a local area network (LAN) card (e.g. for Ethernet™ or an Asynchronous Transfer Model (ATM) network) to provide a data communication connection to a compatible LAN. Wireless links can also be implemented. In any such implementation, communication interface 917 sends and receives electrical, electromagnetic, or optical signals that carry digital data streams representing various types of information. Further, the communication interface 917 can include peripheral interface devices, such as a Universal Serial Bus (USB) interface, a PCMCIA (Personal Computer Memory Card International Association) interface, etc. Although a single communication interface 917 is depicted in FIG. 9, multiple communication interfaces can also be employed.

The network link 919 typically provides data communication through one or more networks to other data devices. For example, the network link 919 may provide a connection through local network 921 to a host computer 923, which has connectivity to a network 925 (e.g. a wide area network (WAN) or the global packet data communication network now commonly referred to as the “Internet”) or to data equipment operated by a service provider. The local network 921 and the network 925 both use electrical, electromagnetic, or optical signals to convey information and instructions. The signals through the various networks and the signals on the network link 919 and through the communication interface 917, which communicate digital data with the computer system 900, are exemplary forms of carrier waves bearing the information and instructions.

The computer system 900 can send messages and receive data, including program code, through the network(s), the network link 919, and the communication interface 917. In the Internet example, a server (not shown) might transmit requested code belonging to an application program for implementing an embodiment of the invention through the network 925, the local network 921 and the communication interface 917. The processor 903 may execute the transmitted code while being received and/or store the code in the storage device 909, or other non-volatile storage for later execution. In this manner, the computer system 900 may obtain application code in the form of a carrier wave.

The term “computer-readable medium” as used herein refers to any medium that participates in providing instructions to the processor 903 for execution. Such a medium may take many forms, including but not limited to non-volatile media, volatile media, and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving an input from a user for generating an alert on a mobile station; and
generating, in response to the input, a control signal to activate the alert on the mobile station irrespective of any pre-existing alert setting of the mobile station.

2. A method according to claim 1, wherein the input includes a code assigned to the user for a find-device service to locate the mobile station through the alert emanated from the mobile station.

3. A method according to claim 2, wherein the receiving step is performed at a voice mail system configured to receive the code as part of a voice call placed by the user to the voice mail system.

4. A method according to claim 2, wherein the receiving step is performed at a text messaging system configured to receive the code as part of a text message entered by the user to the text messaging system.

5. A method according to claim 2, wherein the receiving step is performed at a website configured to receive the code as part of a message entered by the user using a browser application.

6. A method according to claim 1, wherein the alert includes an aural indicator, a visual indicator, a vibratory indicator, or a combination thereof.

7. A method according to claim 1, wherein the input includes a code assigned to the user for an emergency override service to notify a subscriber associated with the mobile station of an emergency or urgent situation.

8. A method according to claim 7, wherein the control signal causes the alert to be activated during a call busy condition of the mobile station.

9. A method according to claim 7, wherein the mobile station is configured to display emergency contact information in response to the control signal.

10. A system comprising:
a communication interface configured to receive an input from a user for generating an alert on a mobile station; and
a processor coupled to the communication interface and configured to generate, in response to the input, a control signal to activate the alert on the mobile station irrespective of any pre-existing alert setting of the mobile station.

11. A system according to claim 10, wherein the input includes a code assigned to the user for a find-device service to locate the mobile station through the alert emanated from the mobile station.

12. A system according to claim 11, wherein the system includes a voice mail system configured to receive the code as part of a voice call placed by the user to the voice mail system.

13. A system according to claim 11, wherein the system includes a text messaging system configured to receive the code as part of a text message entered by the user to the text messaging system.

14. A system according to claim 11, wherein the system includes a website configured to receive the code as part of a message entered by the user using a browser application.

15. A system according to claim 10, wherein the alert includes an aural indicator, a visual indicator, a vibratory indicator, or a combination thereof.

16. A system according to claim 10, wherein the input includes a code assigned to the user for an emergency override service to notify a subscriber associated with the mobile station of an emergency or urgent situation.

17. A system according to claim 16, wherein the control signal causes the alert to be activated during a call busy condition of the mobile station.

18. A system according to claim 16, wherein the mobile station is configured to display emergency contact information in response to the control signal.

19. A method comprising:
receiving, at a mobile station, a control signal to activate a distinctive alert on the mobile station irrespective of any pre-existing alert setting of the mobile station, wherein the control signal is generated based on a code provided to a subscriber associated with the mobile station, the code being assigned to the subscriber for a find-device service;
configuring the alert setting to provide the distinctive alert in response to the received control signal; and
activating the distinctive alert to permit determining location of the mobile station.

20. A method according to claim 19, wherein the code is input to a voice mail system configured to receive the code as part of a voice call placed by the subscriber.

21. A method according to claim 19, wherein the code is input to a text messaging system configured to receive the code as part of a text message entered by the subscriber.

22. A method according to claim 19, wherein the code is input to a website configured to receive the code as part of a message entered by the subscriber using a browser application.

23. A method comprising:
receiving, at a mobile station, a control signal to activate a distinctive alert on the mobile station for notifying a subscriber associated with the mobile station of an emergency or urgent situation, wherein the control signal is generated based on a code provided to a subscriber, the code being assigned to the subscriber for an emergency override service;
activating the distinctive alert to notify the subscriber of the situation; and
selectively displaying emergency contact information.

24. A method according to claim 23, wherein the code is input to a voice mail system configured to receive the code as part of a voice call placed by the subscriber.
